(19) United States
(12) Patent Application Publication
(10) Pub. No.: US 2025/0221394 A1
(43) Pub. Date: Jul. 10, 2025

(54) Insect Capturing Assembly

(71) Applicant: Oronzo Di Bono, Egg Harbor City, NJ (US)

(72) Inventor: Oronzo Di Bono, Egg Harbor City, NJ (US)

(21) Appl. No.: 18/408,713

(22) Filed: Jan. 10, 2024

(51) Int. Cl. A01M 1/14; A01M 1/02; A01M 1/10

(52) U.S. Cl. CPC A01M 1/145; A01M 1/106

(57) ABSTRACT

An insect capturing assembly includes an ornament that is substantially hollow and a gripping element that is integrated into the ornament. A tube is slidably integrated into the ornament and the gripping element releasably engages the tube. The ornament is positionable in a stored position has the tube contained within the ornament and the ornament is positionable in a deployed position having the tube extending outwardly from the ornament. An adhesive sleeve is wrapped around the tube to capture flying insects that land on the adhesive sleeve. A base is coupled to the tube and the base is positionable on a horizontal support surface. A plurality of lights is each coupled to the base such that each of the lights emits light when the lights are turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to insect devices and more particularly pertains to a new insect device for capturing flying insects. The device includes an ornament and a tube that is slidably integrated into the ornament. The tube can be extended out of the ornament or the tube can be contained within the ornament. An adhesive sleeve is wrapped around the tube for capturing flying insects when the tube is extended out of the ornament. A base is coupled the tube and a plurality of lights is coupled to the base for emitting light.

### (2) Description of Related Art including information disclosed under 37 CFR 1.97 and 1.98.

The prior art discloses a variety of insect capturing devices that includes an insect trap device which includes a base structure and a decorative cover for the base structure, a fly trap device that is structured to resemble a potted plant and a yellow jacket trap device that includes a perforated cylinder and a sleeve that is positionable around the perforated cylinder. In no instance does the prior art disclose an ornamental insect capturing device that includes an ornament and an adhesive tube that is positionable in a deployed position having the adhesive tube being exposed or a stored position having the adhesive tube being stored within the ornament.

### BRIEF SUMMARY OF THE INVENTION

An embodiment of the disclosure meets the needs presented above by generally comprising an ornament that is substantially hollow and a gripping element that is integrated into the ornament. A tube is slidably integrated into the ornament and the gripping element releasably engages the tube. The ornament is positionable in a stored position has the tube contained within the ornament and the ornament is positionable in a deployed position having the tube extending outwardly from the ornament. An adhesive sleeve is wrapped around the tube to capture flying insects that land on the adhesive sleeve. A base is coupled to the tube and the base is positionable on a horizontal support surface. A plurality of lights is each coupled to the base such that each of the lights emits light when the lights are turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an insect capturing assembly according to an embodiment of the disclosure.

FIG. 2 is a front view of an embodiment of the disclosure showing a tube in a deployed position.

FIG. 3 is a front perspective view of an embodiment of the disclosure showing a tube in a stored position.

FIG. 4 is a cross sectional view taken along line 4-4 of FIG. 3 of an embodiment of the disclosure.

FIG. 5 is an exploded perspective view of an embodiment of the disclosure.

FIG. 6 is a perspective in-use view of an embodiment of the disclosure.

### DETAILED DESCRIPTION OF THE INVENTION

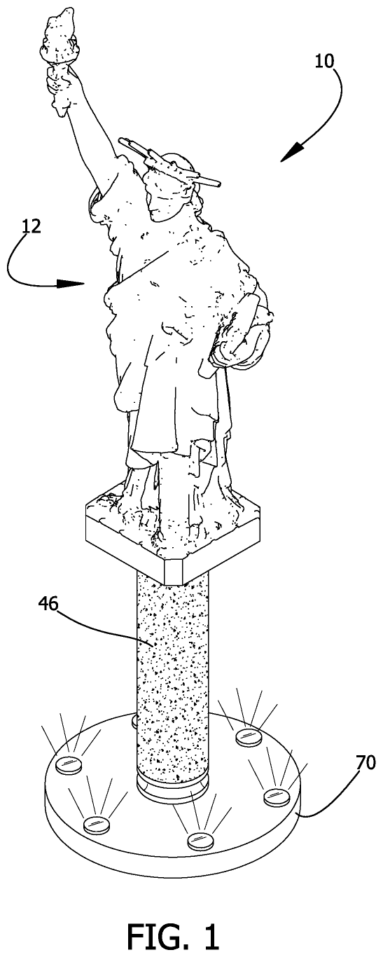

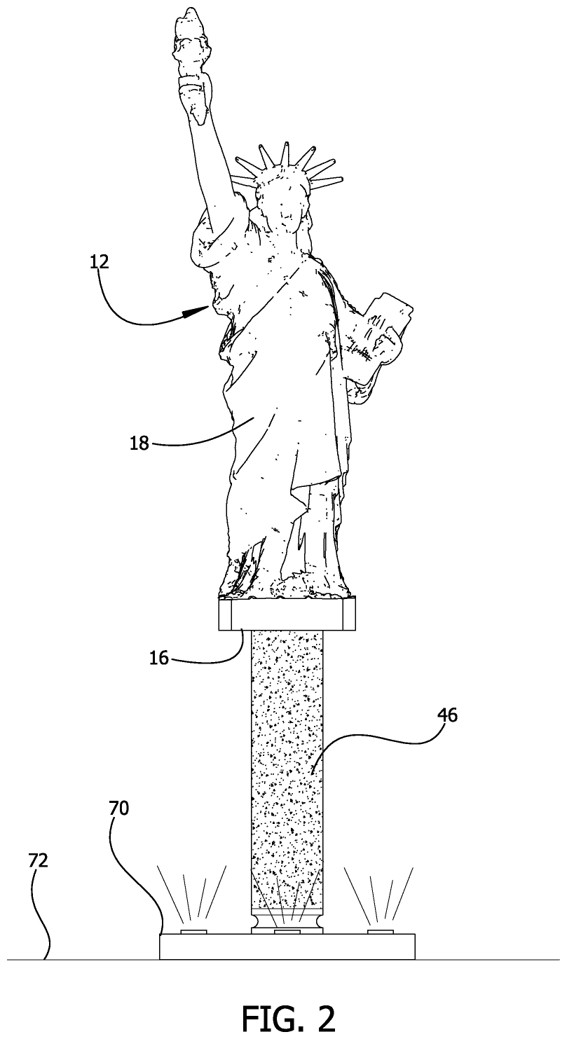

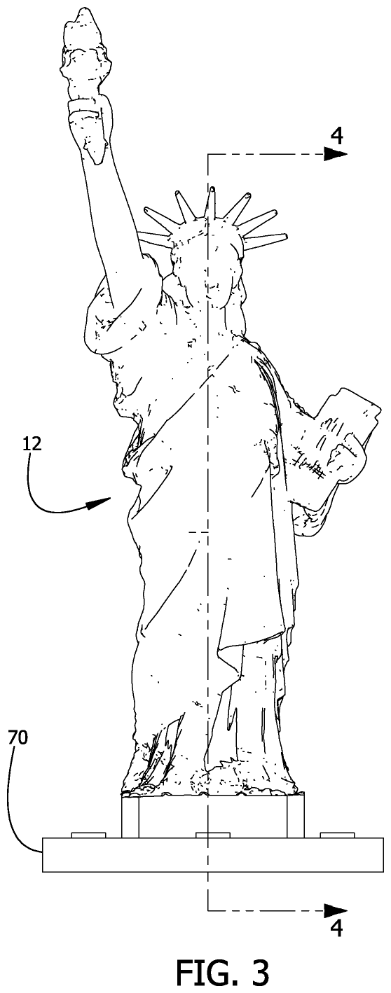

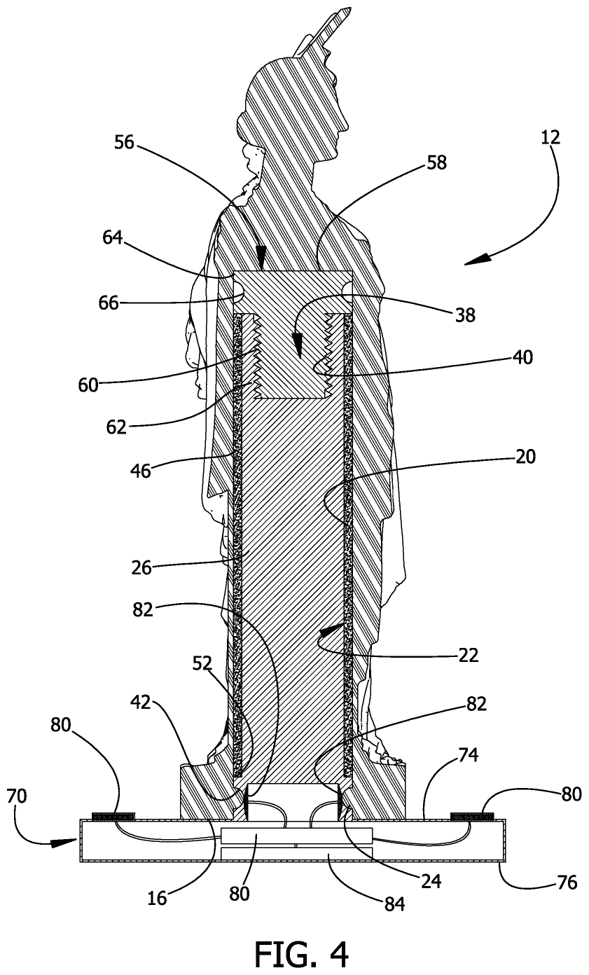

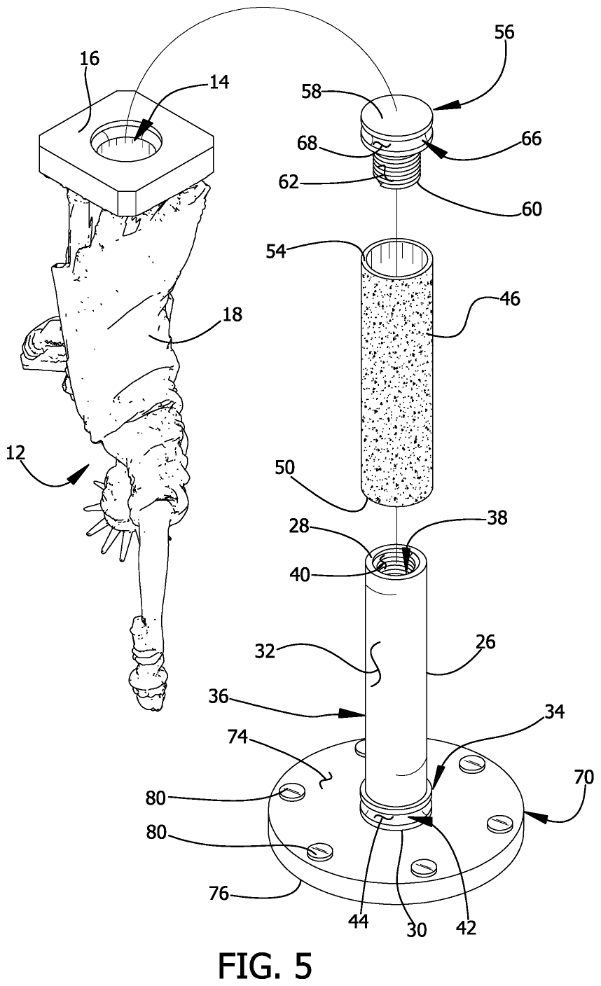

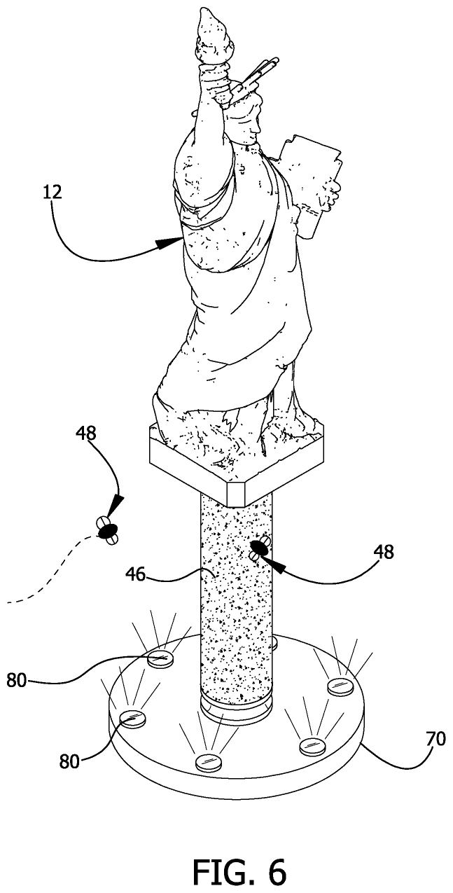

With reference now to the drawings, and in particular to FIGS. 1 through 6 thereof, a new insect device embodying the principles and concepts of an embodiment of the disclosure and generally designated by the reference numeral 10 will be described.

As best illustrated in FIGS. 1 through 6, the insect capturing assembly 10 generally comprises an ornament 12 that is substantially hollow and the ornament 12 has a gripping element 14 that is integrated into the ornament 12. The ornament 12 has a bottom end 16 and an outside wall 18 extending upwardly from the bottom end 16. The bottom end 16 has a well 20 extending into the ornament 12 and the well 20 has a bounding surface 22. The ornament 12 has a nub 24 extending outwardly from the bounding surface 22 at a point located proximate the bottom end 16. The nub 24 extends around a full diameter of the bounding surface 22 and the nub 24 defines the gripping element 14. Additionally, the outside wall 18 of the ornament 12 may be structured to resemble the statue of liberty, for example. or other recognizable monument or structure.

A tube 26 is slidably integrated into the ornament 12 and the gripping element 14 of the ornament 12 releasably engages the tube 26. The ornament 12 is positionable in a stored position having the tube 26 being contained within the ornament 12. Conversely, the ornament 12 is positionable in a deployed position having the tube 26 extending outwardly from the ornament 12. The tube 26 has an upper end 28, a lower end 30 and an outer surface 32 extending between the upper end 28 and the lower end 30. The outer surface 32 has a first portion 34 extending upwardly from the lower end 30 and the outer surface 32 has a second portion 36 extending between the first portion 34 and the upper end 28. The second portion 36 has a diameter that is less than a diameter of the first portion 34. The tube 26 has a well 38 extending into the upper end 28 and the well 38 in the tube 26 has a bounding surface 40 that is threaded. The tube 26 has a first groove 42 that is integrated into the first portion 34 of the outer surface 32 and the first groove 42 extends around a full circumference of the first portion 34. Furthermore, the first groove 42 has a bounding surface 44 that is concavely arcuate with respect to the first portion 34 of the outer surface 32 thereby facilitating the nub 24 on the ornament 12 to slide into and out of the first groove 42.

An adhesive sleeve 46 is wrapped around the tube 26 and the adhesive sleeve 46 is comprised of an adhesive material thereby facilitating the adhesive sleeve 46 to cap56ture flying insects 48 that land on the adhesive sleeve 46. The adhesive sleeve 46 has a bottom end 50 which abuts a top surface 52 of the first portion 34 of the outer surface 32 of the tube 26 when the adhesive sleeve 46 is positioned around the tube 26. The adhesive sleeve 46 has a top end 54 is aligned with the upper end 28 of the tube 26 when the adhesive sleeve 46 is positioned around the tube 26. Furthermore, the adhesive sleeve 46 may be infused with a chemical attractant for attracting the flying insects 48 to land on the adhesive sleeve 46.

A cap 56 is provided which has a head 58 and a stem 60 extending downwardly from the head 58. The stem 60 has an outside surface 62 that is threaded and the stem 60 is insertable into the well 38 in the upper end 28 of the tube 26 having the outside surface 62 of the stem 60 threadably engaging the bounding surface 40 of the well 38 in the upper end 28 such that the head 58 rests against the upper end 28 of the tube 26. The top end 54 of the adhesive sleeve 46 abuts the head 58 when the cap 56 is attached to the tube 26 for retaining the adhesive sleeve 46 on the tube 26. The head 58 has an exterior surface 64 and a second groove 66 is integrated into the exterior surface 64. The second groove 66 extends around a full circumference of the exterior surface 64 and the second groove 66 has a bounding surface 68 that is concavely arcuate with respect to the exterior surface 64 thereby facilitating the nub 24 in the ornament 12 to slide into and out of the second groove 66. The nub 24 engages the first groove 42 in the first portion 34 of the outer surface 32 of the tube 26 when the tube 26 is positioned in the stored position. Additionally, the nub 24 engages the second groove 66 in the exterior surface 64 of the head 58 of the cap 56 when the tube 26 is positioned in the deployed position. Additionally, the nub 24 may be comprised of a resiliently compressible material, including but not being limited to rubber or silicone, thereby facilitating the nub 24 to deform to facilitate the nub 24 to be removed from the first groove 42 or the second groove 66.

A base 70 is coupled to the tube 26 and the base 70 is positionable on a horizontal support surface 72 thereby facilitating the tube 26 to be vertically oriented. In this way the tube 26 is positioned to facilitate the flying insects 48 to land on the tube 26. The base 70 has a top surface 74 and a bottom surface 76; the lower end 30 of the tube 26 is coupled to the top surface 74 of the base 70 and the tube 26 is centrally positioned on the base 70. Additionally, the base 70 has a diameter that is greater than a diameter of the tube 26. A plurality of lights 78 is provided and each of the lights 78 is coupled to the base 70 such that each of the lights 78 emits light when the lights 78 are turned on. Each of the lights 78 is positioned on the top surface 74 of the base 70 and the lights 78 are spaced apart from each other and are distributed around the tube 26. Furthermore, each of the lights 78 may comprise a light emitting diode or other type of electronic light emitter than can emit light in a variety of colors.

A processor 80 is integrated into the base and the processor 80 receives an actuate input and a de-actuate input. The processor 80 is electrically coupled to each of the plurality of lights 78; each of the plurality of lights 78 is turned on when the processor 80 receives the actuate input and each of the plurality of lights 78 is turned off when the processor 80 receives the de-actuate input. A pair of sensors 82 is each integrated into the tube 26 and each of the pair of sensors 82 is electrically coupled to the processor 80. Each of the pair of sensors 82 is aligned with the first groove 42 in the first portion 34 of the outer surface 32 of the tube 26. Each of the pair of sensors 82 is engaged by the nub 24 in the ornament 12 when the tube 26 is in the stored position. The nub 24 in the ornament disengages the pair of sensors 82 when the tube 26 is in the deployed position. Furthermore, the processor 80 receives the actuate input when the nub 24 engages the sensors 82 and the processor 80 receives the de-actuate input when the nub 24 disengages the sensors 82. A power supply 84 is positioned in the base 70, the power supply 84 is electrically coupled to the processor 80 and the power supply 84 comprises at least one battery.

In use, the adhesive sleeve 46 is positioned around the tube 26 and the cap 56 is threaded into the tube 26 to retain the adhesive sleeve 46 around the tube 26. The ornament 12 is slid downwardly over the tube 26 and the ornament 12 is positioned in the deployed position thereby exposing the adhesive sleeve 46 on the tube 26. In this way flying insects 48 can be captured on the adhesive sleeve 46 when the flying insects 48 land on the adhesive sleeve 46. Additionally, the lights 78 are turned on when the tube is in the deployed position for illuminating the area in which the ornament 12 is positioned. The ornament 12 is positioned in the stored position to conceal the tube 26 within the ornament 12 such that the flying insects 48 on the adhesive sleeve 46 are not visible to an observer. Furthermore, the lights 78 are turned off when the tube 26 is in the stored position. The ornament 12 is removed from the tube 26 and the cap 56 is uncoupled from the tube 26 to facilitate the adhesive sleeve 46 to be replaced when the adhesive sleeve 46 becomes covered with the flying insects 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect capturing assembly for emitting light and capturing insects, said assembly comprising:
an ornament being substantially hollow, said ornament having a gripping element being integrated into said ornament;
a tube being slidably integrated into said ornament, said gripping element of said ornament releasably engaging said tube, said ornament being positionable in a stored position having said tube being contained within said ornament, said ornament being positionable in a deployed position having said tube extending outwardly from said ornament;
an adhesive sleeve being positionable around said tube, said adhesive sleeve being comprised of an adhesive material thereby facilitating said adhesive sleeve to capture flying insects that land on said adhesive sleeve;
a base being coupled to said tube, said base being positionable on a horizontal support surface thereby facilitating said tube to be vertically oriented wherein said tube is configured to be positioned to facilitate the flying insects to land on said tube; and
a plurality of lights, each of said lights being coupled to said base such that each of said lights emits light when said lights are turned on.

2. The assembly according to claim 1, wherein:
said ornament has a bottom end and an outside wall extending upwardly from said bottom end;
said bottom end has a well extending into said ornament;
said well has a bounding surface;
said ornament having a nub extending outwardly from said bounding surface at a point located proximate said bottom end; and
said nub extends around a full diameter of said bounding surface, said nub defining said gripping element.

3. The assembly according to claim 2, wherein:
said tube has an upper end, a lower end and an outer surface extending between said upper end and said lower end;
said outer surface has a first portion extending upwardly from said lower end;
said outer surface has a second portion extending between said first portion and said upper end;
said second portion has a diameter being less than a diameter of said first portion;
said tube has a well extending into said upper end;
said well in said tube has a bounding surface being threaded;
said tube has a first groove being integrated into said first portion of said outer surface;
said first groove extends around a full circumference of said first portion; and
said first groove has a bounding surface being concavely arcuate with respect to said first portion of said outer surface thereby facilitating said nub on said ornament to slide into and out of said first groove.

4. The assembly according to claim 3, wherein:
said adhesive sleeve extends around a full circumference of said outer surface of said tube;
said adhesive sleeve has a bottom end which abuts a top surface of said first portion of said outer surface of said tube when said adhesive sleeve is positioned around said tube; and
said adhesive sleeve has a top end being aligned with said upper end of said tube when said adhesive sleeve is positioned around said tube.

5. The assembly according to claim 4, wherein:
said assembly includes a cap which has a head and a stem extending downwardly from said head;
said stem has an outside surface being threaded;
said stem is insertable into said well in said upper end of said tube having said outside surface of said stem threadably engaging said bounding surface of said well in said upper end such that said head rests against said upper end of said tube; and
said top end of said adhesive sleeve abuts said head when said cap is attached to said tube for retaining said adhesive sleeve on said tube.

6. The assembly according to claim 5, wherein:
said head has an exterior surface;
said head has a second groove being integrated into said exterior surface;
said second groove extends around a full circumference of said exterior surface; and
said second groove has a bounding surface being concavely arcuate with respect to said exterior surface thereby facilitating said nub on said ornament to slide into and out of said second groove.

7. The assembly according to claim 6, wherein:
said nub on said ornament engages said first groove in said first portion of said outer surface of said tube when said tube is positioned in said stored position; and
wherein said nub on said ornament engages said second groove in said exterior surface of said head of said cap when said tube is positioned in said deployed position.

8. The assembly according to claim 3, wherein:
said base has a top surface and a bottom surface, said lower end of said tube being coupled to said top surface of said base, said tube being centrally positioned on said base, said base having a diameter being greater than a diameter of said tube; and
each of said lights is positioned on said top surface of said base, said lights being spaced apart from each other and being distributed around said tube.

9. The assembly according to claim 1, wherein:
said assembly includes a processor being integrated into said base;
said processor receives an actuate input and a de-actuate input;
said processor is electrically coupled to each of said plurality of lights;
each of said plurality of lights is turned on when said processor receives said actuate input; and
each of said plurality of lights is turned off when said processor receives said de-actuate input.

10. The assembly according to claim 2, wherein:
said assembly includes a processor, said processor receiving an actuate input and a de-actuate input;
said assembly includes a pair of sensors;
each of said pair of sensors is integrated into said tube;
each of said pair of sensors is electrically coupled to said processor;
each of said pair of sensors is aligned with said first groove in said first portion of said outer surface of said tube;
each of said pair of sensors is engaged by said nub in said ornament when said tube is in said stored position;
said nub in said ornament disengages said pair of sensors when said tube is in said deployed position;
said processor receives said actuate input when said nub engages said sensors; and
said processor receives said de-actuate input when said nub disengages said sensors.

11. An insect capturing assembly for emitting light and capturing insects, said assembly comprising:
an ornament being substantially hollow, said ornament having a gripping element being integrated into said ornament, said ornament having a bottom end and an outside wall extending upwardly from said bottom end, said bottom end having a well extending into said ornament, said well having a bounding surface, said ornament having a nub extending outwardly from said bounding surface at a point located proximate said bottom end, said nub extending around a full diameter of said bounding surface, said nub defining said gripping element;
a tube being slidably integrated into said ornament, said gripping element of said ornament releasably engaging said tube, said ornament being positionable in a stored position having said tube being contained within said ornament, said ornament being positionable in a deployed position having said tube extending outwardly from said ornament, said tube having an upper end, a lower end and an outer surface extending between said upper end and said lower end, said outer surface having a first portion extending upwardly from said lower end, said outer surface having a second portion extending between said first portion and said upper end, said second portion having a diameter being less than a diameter of said first portion, said tube having a well extending into said upper end, said well in said tube having a bounding surface being threaded, said tube having a first groove being integrated into said first portion of said outer surface, said first groove extending around a full circumference of said first portion, said first groove having a bounding surface being concavely arcuate with respect to said first portion of said outer surface thereby facilitating said nub on said ornament to slide into and out of said first groove;
an adhesive sleeve being positionable around said tube, said adhesive sleeve being comprised of an adhesive material thereby facilitating said adhesive sleeve to capture flying insects that land on said adhesive sleeve, said adhesive sleeve extending around a full circumference of said outer surface of said tube, said adhesive sleeve having a bottom end which abuts a top surface of said first portion of said outer surface of said tube when said adhesive sleeve is positioned around said tube, said adhesive sleeve having a top end being aligned with said upper end of said tube when said adhesive sleeve is positioned around said tube;
a cap having a head and a stem extending downwardly from said head, said stem having an outside surface being threaded, said stem being insertable into said well in said upper end of said tube having said outside surface of said stem threadably engaging said bounding surface of said well in said upper end such that said head rests against said upper end of said tube, said top end of said adhesive sleeve abutting said head when said cap is attached to said tube for retaining said adhesive sleeve on said tube, said head having an exterior surface, said head having a second groove being integrated into said exterior surface, said second groove extending around a full circumference of said exterior surface, said second groove having a bounding surface being concavely arcuate with respect to said exterior surface thereby facilitating said nub in said ornament to slide into and out of said second groove;
wherein said nub engages said first groove in said first portion of said outer surface of said tube when said tube is positioned in said stored position;
wherein said nub engages said second groove in said exterior surface of said head of said cap when said tube is positioned in said deployed position;
a base being coupled to said tube, said base being positionable on a horizontal support surface thereby facilitating said tube to be vertically oriented wherein said tube is configured to be positioned to facilitate the flying insects to land on said tube, said base having a top surface and a bottom surface, said lower end of said tube being coupled to said top surface of said base, said tube being centrally positioned on said base, said base having a diameter being greater than a diameter of said tube;
a plurality of lights, each of said lights being coupled to said base such that each of said lights emits light when said lights are turned on, each of said lights being positioned on said top surface of said base, said lights being spaced apart from each other and being distributed around said tube;
a processor being integrated into said base, said processor receiving an actuate input and a de-actuate input, said processor being electrically coupled to each of said plurality of lights, each of said plurality of lights being turned on when said processor receives said actuate input, each of said plurality of lights being turned off when said processor receives said de-actuate input;
a pair of sensors, each of said pair of sensors being integrated into said tube, each of said pair of sensors being electrically coupled to said processor, each of said pair of sensors being aligned with said first groove in said first portion of said outer surface of said tube, each of said pair of sensors being engaged by said nub in said ornament when said tube is in said stored position, said nub in said ornament disengaging said pair of sensors when said tube is in said deployed position, said processor receiving said actuate input when said nub engages said sensors, said processor receiving said de-actuate input when said nub disengages said sensors; and
a power supply being positioned in said base, said power supply being electrically coupled to said processor, said power supply comprising at least one battery.
